(19) United States
(12) Patent Application Publication
(10) Pub. No.: US 2014/0332474 A1
(43) Pub. Date: Nov. 13, 2014

(54) Process for reducing the total organic carbon of aqueous compositions

(71) Applicant: SOLVAY SA, Brussels (BE)

(72) Inventor: Bruno Fouchet, Shanghai (CN)

(21) Appl. No.: 14/366,278

(22) PCT Filed: Dec. 12, 2012
(86) PCT No.: PCT/EP2012/075211

§ 371 Date: Jun. 18, 2014

(30) Foreign Application Priority Data
Dec. 19, 2011 (EP) 11194209.0

(51) Int. Cl. C02F 1/76

(52) U.S. Cl. CPC C02F 1/76; C02F 2101/30
USPC 210/750

(57) ABSTRACT

Process for reducing the Total Organic Carbon of a first aqueous composition (A) comprising submitting (A) to a treatment with active chlorine at a first pH value in order to obtain a second aqueous composition (B), submitting at least one part of (B) to a venting treatment at a second pH value lower than the first pH value in order to obtain a third aqueous composition (C) and submitting at least one part of (C) to a treatment with active chlorine at a third pH value lower than the second pH value in order to obtain a fourth aqueous composition (D) with a Total Organic Carbon lower than the Total Organic Carbon of (A).

The present application claims benefit of European patent application no 11194209.0 filed on Dec. 19, 2011 the content of which is incorporated herein by reference for all purposes.

Should the disclosure of any of the patents, patent applications, and publications which are incorporated herein by reference conflict with the description of the present application to the extent that it may render a term unclear, the present description shall take precedence.

The present invention relates to a process for reducing the Total organic Carbon (TOC) of aqueous compositions.

The present invention relates more specifically to a process for reducing the Total Organic Carbon (TOC) of aqueous compositions, by oxidation with active chlorine.

International application WO 2009/095429 filed under the name of SOLVAY Société Anonyme discloses a process for degrading organic substances in an aqueous composition with the use of hypochlorite. According to one embodiment, the oxidation of the aqueous composition is carried out at a first pH value and continued at a second lower pH value. Said procedure leads to a non-efficient use of the oxidant.

The object of the present invention is to provide a new process for reducing the Total Organic Carbon (TOC) of an aqueous composition by oxidation in which the oxidant is used in a more efficient way.

For this purpose, and in a first embodiment, the present invention relates to a process for reducing the Total Organic Carbon of a first aqueous composition (A) comprising submitting (A) to a treatment with active chlorine at a first pH value in order to obtain a second aqueous composition (B), submitting at least one part of (B) to a venting treatment at a second pH value lower than the first pH value in order to obtain a third aqueous composition (C) and submitting at least one part of (C) to a treatment with active chlorine at a third pH value lower than the second pH value in order to obtain a fourth aqueous composition (D) with a Total Organic Carbon lower than the Total Organic Carbon of (A).

One of the essential features of the present invention lies in the venting treatment at an intermediate pH value. Such treatment leads to a more efficient use of the oxidant as well as to a possible recycling of said oxidant. A more efficient use of the oxidant allows reaching a lower Total Organic Content (TOC) in the treated aqueous composition. Such improvement is particularly difficult to obtain for low TOC values and several applications require aqueous solutions with very low TOC.

Without willing to be tied by any theory, it is believed that the venting at an intermediate pH value allows removing the carbon dioxide formed from oxidation of the organic compounds present in the first aqueous composition (A) before the treatment at the first pH while retaining most of the oxidant remaining in the aqueous composition, for further oxidation. Such prior removal of carbon dioxide also leads to less contamination of the non reacted oxidant hence to a recovering of said oxidant in further process steps and subsequent possible recycling for said non reacted oxidant.

In the process according to the invention, the expression Total Organic carbon (TOC) is understood to mean the carbon in the form of organic compounds as defined in standard ASTM D7573-09.

In the process according to the invention, the organic compound may be as described in application WO 2009/095429 in the name of SOLVAY SA, of which the content, and more specifically the passage from page 2, line 9, to page 3, line 11, is incorporated by reference and in International application WO 2012/016872 in the name of SOLVAY (Société Anonyme), of which the content, and more specifically the passage from page 3, line 24, to page 5, line 20, is incorporated herein by reference.

In the process according to the invention, the organic compound is preferably chosen from the group consisting of glycerol, monochloropropanediols, dichloropropanols, acetic acid, propionic acid, butyric acid, capric acid, caproic acid, caprylic acid, and any mixture thereof.

The total organic carbon (TOC) of the first aqueous composition (A) is usually higher than or equal to 0.1 g C/l, preferably higher than or equal to 0.5 g C/l and more preferably higher than or equal to 1 g C/l. That TOC is usually lower than or equal to 20 g C/l, preferably lower than or equal to 10 g C/l and more preferably lower than or equal to 5 g C/l.

The total organic carbon (TOC) of the fourth aqueous composition (D) is usually lower than or equal to 30 mg C/l, preferably lower than or equal to 20 mg C/l, more preferably lower than or equal to 10 mg C/l, yet more preferably lower than or equal to 5 mg C/l, still more preferably lower than or equal to 1 mg C/l. That TOC is usually higher than or equal to 0.1 mg C/l.

In the process according to the invention, the reduction of the TOC is usually higher than or equal to 50%, in many cases higher than or equal to 80%, generally higher than or equal to 90%, frequently higher than or equal to 95%, often higher than or equal to 99%, specifically higher than or equal to 99.9%, and in particular higher than or equal to 99.995%. That reduction is usually calculated on the basis of the TOC quantities in aqueous compositions (A) and (D) expressed in g of C when the process is discontinuous or the flow rates of TOC in the aqueous composition (A) before the treatment at the first pH value and in aqueous composition (D) after the treatment at the third pH value.

The Total Organic Carbon can be and is preferably measured according to standard ASTM D7573-09.

Using the oxidant in a more efficient way, in the process according to the invention, allows obtaining a reduction of the TOC as disclosed here above and a TOC of the fourth aqueous composition (D) as disclosed here above. In the process according to the invention, the content of the organic compounds in the first aqueous composition (A) is usually such that the chemical oxygen demand (COD) of the aqueous composition to be treated is higher than or equal to 0.3 g O/kg, preferably higher than or equal to 1.5 g O/kg and more preferably higher than or equal to 3 g O/kg. That COD is usually lower than or equal to 60 g O/kg, preferably lower than or equal to 30 g O/kg and more preferably lower than or equal to 15 g O/kg.

The Chemical Oxygen Demand (COD) of the aqueous composition (D) is usually lower than or equal to 90 mg O/l, preferably lower than or equal to 60 mg O/l, more preferably lower than or equal to 30 mg O/l, yet more preferably lower than or equal to 15 mg O/l, still more preferably lower than or equal to 3 mg O/l. That COD is usually higher than or equal to 0.1 mg O/l.

In the process according to the invention, the expression Chemical Oxygen Demand is defined and measured as in standard ISO 6060. In the process according to the invention, the expression “active chlorine” is understood to mean molecular chlorine and its reaction products with water or with a basic agent, like for instance, ammonium hydroxide, an alkaline hydroxide, an alkaline earth hydroxide, or a mixture thereof. Sodium hydroxide or a calcium hydroxide or a mixture thereof is preferred and sodium hydroxide is more preferred. Hypochlorous acid, sodium hypochlorite, molecular chlorine, chlorine dioxide and mixture thereof are convenient. The active chlorine can be added to and/or generated in the aqueous composition (A) by any means. Adding sodium hypochlorite is a convenient way.

The amount of active chlorine can be measured by any means, as for example by UV absorption or by iodometry. UV absorption is specifically well suited for automated on line analysis. Iodometry is particularly convenient for off-line analysis.

In the process according to the invention, the amount of active chlorine used is usually such that the molar ratio between said active chlorine expressed as hypochlorite and the Carbon Oxygen Demand COD (expressed in mol of O) of the aqueous composition (A) before reaction, is higher than or equal to 1, preferably higher than or equal to 1.2 and most preferably higher than or equal to 1.4. That amount is usually such that the molar ratio between the hypochlorite added and the COD (expressed in mol of O) of the aqueous composition (A) before reaction, is lower than or equal to 8, preferably lower than or equal to 4 and most preferably lower than or equal to 3.

In the process according to the invention, the amount of active chlorine used is usually such that the mass ratio between said active chlorine expressed in g of chlorine (Cl₂) and the Total Organic Carbon expressed in g of carbon (C) of the aqueous composition (A) before reaction, is usually higher than or equal to 1, often higher than or equal to 5, frequently higher than or equal to 10 and in many cases higher than or equal to 15. That amount of active chlorine is usually such that that mass ratio is lower than or equal to 30, frequently lower than or equal to 25 and often lower than or equal to 20.

In the process according to the invention, the active chlorine can be provided under any form such as for example molecular chlorine (Cl₂), hypochlorous acid, sodium hypochlorite and mixture thereof. Active chlorine can be provided in any of the aqueous compositions (A), (B) or (C), preferably in (A) and more preferably in (A) and (C).

In the process according to the invention, the term “venting” is understood to mean the removal of a dissolved component from a liquid phase. Such a removal can be carried out by a release or discharge of a gas through an opening.

In the process according to the invention, the venting treatment is preferably a flashing treatment, a stripping treatment or a combination thereof. A flashing treatment is more preferred.

The term “flashing” is understood to mean a gas release from a liquid by release of pressure usually with no provision of matter or energy. The pressure release can be carried out according to any time sequence.

In the process according to the invention, the flashing treatment is usually carried out at a pressure higher than or equal to 0.5 bar, preferably higher than or equal to 1 bar and most preferably higher than or equal to 2.5 bar. This pressure is usually lower than or equal to 10 bar, preferably lower than or equal to 5 bar and most preferably lower than or equal to 3.5 bar. This pressure is usually equivalent to the pressure of the treatment at the first pH value.

In the process according to the invention, the flashing treatment is usually carried out at a temperature higher than or equal to 80° C., preferably higher than or equal to 100° C. and most preferably higher than or equal to 120° C. This temperature is usually lower than or equal to 180° C., preferably lower than or equal to 160° C. and most preferably lower than or equal to 140° C. This temperature is usually equivalent to the temperature of the treatment at the first pH value.

In the process according to the invention, the term “stripping” is understood to mean the separation of a substance by entrainment using a gas, the vapour of a pure material or a mixture thereof (stripping agent) which dissolves or does not dissolve said substance.

In the process according to the invention, said stripping agent may be chosen from the group consisting of air, oxygen-depleted air, nitrogen, oxygen, steam, and mixtures of at least two thereof. Steam, air and oxygen-depleted air are preferred stripping agents and steam is a more preferred stripping agent. A mixture of steam and oxygen-depleted air may also be suitable.

In the process according to the invention, said stripping agent may be added to the second aqueous composition (B), generated from said composition (B), or both.

In the process according to the invention, the conditions of the stripping treatment can be such as described in International application WO 2012/016872 filed under the name of SOLVAY SA, the content of which is incorporated herein by reference more specifically the passage from page 7, line 26, to page 9, line 3.

In the process according to the invention, the stripping treatment is usually carried out under at least one of the following conditions:

A temperature higher than 10° C. and lower than 200° C.

A pressure higher than 50 mbar absolute and lower than or equal to 5 bar absolute.

In the process according to the invention, when the stripping agent is steam, the stripping treatment is carried out at a temperature generally greater than or equal to 10° C., often greater than or equal to 30° C., frequently greater than or equal to 40° C. and more specifically greater than or equal to 60° C., in particular greater than or equal to 80° C. and very particularly greater than or equal to 90° C. This temperature is generally less than or equal to 200° C., often less than or equal to 160° C., frequently less than or equal to 140° C., more specifically less than or equal to 120° C. and in particular less than or equal to 100° C.

In the process according to the invention, when the stripping agent is chosen from the group consisting of air, oxygen-depleted air, nitrogen, oxygen, and mixtures of at least two thereof, and in particular when the stripping agent is air or oxygen-depleted air, the temperature of the aqueous composition, which may be a brine, in the stripping zone is generally greater than or equal to 10° C., often greater than or equal to 30° C., frequently greater than or equal to 40° C. and more specifically greater than or equal to 60° C. This temperature in the stripping zone is generally less than or equal to 100° C., often less than or equal to 90° C., frequently less than or equal to 85° C. and more specifically less than or equal to 80° C.

In the process according to the invention, the stripping treatment is generally carried out under a pressure greater than or equal to 50 mbar absolute, often greater than or equal to 100 mbar absolute, frequently greater than or equal to 200 mbar absolute, more specifically greater than or equal to 500 mbar absolute and in particular greater than or equal to 600 mbar absolute. This pressure is generally less than or equal to 5 bar absolute, often less than or equal to 3 bar absolute, frequently less than or equal to 2 bar absolute, more specifically less than or equal to 1.5 bar absolute and in particular less than or equal to 1.3 bar absolute. A pressure greater than or equal to 0.7 bar absolute and less than or equal to 1.2 bar absolute is very suitable.

In the process according to the invention, the treatment of composition (A) with active chlorine usually convert at least one part of the organic compounds present in composition (A) into carbon oxides, as for example, carbon dioxide, carbonates ions or both.

In the process according to the invention the venting treatment, preferably a stripping treatment and more preferably a flashing treatment, usually removes from composition (B) a first vented, preferably stripped and more preferably flashed fraction comprising at least 50%, often at least 75%, frequently at least 90% and in particular at least 99%, of the carbon oxides present in composition (B) before the venting, preferably stripping and more preferably flashing treatment. The vented, preferably stripped and more preferably flashed fraction containing the carbon oxides can be disposed off or send to a High Temperature Oxidation unit.

In the process according to the invention, the fraction of active chlorine present in composition (B) which is recovered in composition (C) is usually of at least 50%, often of at least 75% and frequently of at least 90%.

In the process according to the invention the first pH value is generally higher than or equal to 7, preferably higher than or equal to 7.5, more preferably higher than or equal to 8, and most preferably higher than 8. The first pH value is usually lower than or equal to 13, preferably lower than or equal to 12, more preferably lower than or equal to 11, still more preferably lower than or equal to 10, most preferably lower than or equal to 9 and yet most preferably lower than 9.

In the process according to the invention the second pH value is generally higher than or equal to 5, preferably higher than 5 and more preferably higher than or equal to 5.5. The second pH value is usually lower than or equal to 8, preferably lower than or equal to 7.5, more preferably lower than or equal to 7, still more preferably lower than or equal to 6.4 and most preferably lower than or equal to 6.

In the process according to the invention the third pH value is generally higher than or equal to 3.5, and preferably higher than or equal to 4. The third pH value is usually lower than or equal to 6, preferably lower than or equal to 5.5, and most preferably lower than or equal to 5.

In one preferred embodiment of the process according to the invention, the first pH value is higher than 8 and lower than 9, the second pH value is higher than or equal to 5.5 and lower than or equal to 6, and the third pH value is higher than or equal to 4 and lower than 5. In order to maintain the pH in a given range, the pH is measured and adjusted if necessary.

In the process according to the invention, the second pH value is lower than the first pH value, the difference between the first and the second pH value being usually higher than or equal to 0.1 pH unit, preferably higher than or equal to 0.5 pH unit, more preferably higher than or equal to 1 pH unit, still more preferably higher than or equal to 1.5 pH unit, and most preferably higher than or equal to 2 pH unit. That difference is usually lower than or equal to 4 pH unit, preferably lower than or equal to 3.5 pH unit, and most preferably lower than or equal to 3 pH unit.

In the process according to the invention, the third pH value is lower than the second pH value, the difference between the second and the third pH value being usually higher than or equal to 0.1 pH unit, preferably higher than or equal to 0.5 pH unit, more preferably higher than or equal to 1 pH unit, still more preferably higher than or equal to 1.5 pH unit, and most preferably higher than or equal to 2 pH unit. That difference is usually lower than or equal to 4 pH unit. preferably lower than or equal to 3.5 pH unit, and most preferably lower than or equal to 3 pH unit.

The pH measurement can be done either continuously or periodically. In this last case, the measurement is usually carried out at a frequency sufficiently high to maintain the pH in the set range during at least 80% of the duration of the steps of the process, often during at least 90%, frequently during at least 95% and in particular during at least 99%.

The pH measurement can be carried out “in situ” in the reaction medium under the reaction conditions or “ex situ” in a sample withdrawn from the reaction medium and brought to an adequate temperature and an adequate pressure to assure a good longevity to the pH measurement equipment. A temperature 25° C. and a pressure of 1 bar are examples of adequate temperature and pressure.

The pH measurement can be carried out by any means. Measurement with a pH sensitive electrode is convenient. Such an electrode should be stable in the reaction medium under the reaction conditions and should not contaminate the reaction medium. Glass electrodes for measuring pH are more particularly convenient. Examples of such electrodes are given in Ullmann's Encyclopedia of Industrial Chemistry,© 2005, Wiley-VCH Verlag GmbH & Co. KGaA, Weinheim 10.1002/14356007.e19_e01, pp. 8-15. Electrodes of the type 405-DPAS-SC-K85 supplied by METTLER TOLEDO® or of the types Ceragel CPS71 and Orbisint CPS11 supplied by ENDRESS+HAUSER® are examples of electrodes that can be used.

The pH can be adjusted and maintained at said values either by addition of an acidic compound or by addition of a basic compound. Any acidic or basic compounds can be used to maintain the pH. Inorganic acids and inorganic bases are preferred. Hydrogen chloride, gaseous and/or in aqueous solution, is a more preferred acidic compound. Sodium or calcium hydroxides, solids and/or in aqueous solution and/or suspensions, are more preferred basic compounds, with sodium hydroxide aqueous solutions being most preferred.

The adjustment can be carried out in an automated or in a non-automated mode. It is preferred to use an automated mode wherein the control of the pH is exerted by a closed circuit known as control loop. Such control loops are described in Ullmann's Encyclopedia of Industrial Chemistry,© 2005, Wiley-VCH Verlag GmbH & Co. KGaA, Weinheim 10.1002/14356007.e19_e01, pp.24-27. A PROMINENT® DULCOMETER® system type PHD is an example of an automated pH control and adjustment apparatus that can be used.

In the process according to the invention the aqueous composition (A) usually comprises at least one salt selected from the group consisting of metal chlorides, metal sulphates, metal hydrogen sulphates, metal hydroxides, metal carbonates, metal hydrogen carbonates, metal phosphates, metal hydrogen phosphates, metal borates and mixtures of at least two thereof and the salt is most preferably sodium chloride. Aqueous solutions containing sodium chloride are also known as brines. The aqueous solution (A) according to the process of the invention is often a brine.

The salt content of the aqueous composition (A) is usually higher than or equal to 5 g/kg, often higher than or equal to 10 g/kg, frequently higher than or equal to 20 g/kg, commonly higher than or equal to 30 g/kg of composition to be treated, preferably higher than or equal to 50 g/kg, more preferably higher than or equal to 100 g/kg, still more preferably higher than or equal to 140 g/kg, yet more preferably higher than or equal to 160 g/kg and most preferably higher than or equal to 200 g/kg. That salt content is usually lower than or equal to 270 g/kg of composition to be treated, preferably lower than or equal to 250 g/kg and most preferably lower than or equal to 230 g/kg.

This feature applies in particular to the sodium chloride content of aqueous composition (A).

In the process according to the invention, the aqueous composition (A) may originate from any process that generates an aqueous composition containing an organic compound. When such aqueous composition (A) is a brine, examples of such processes are the processes for manufacturing epoxides, in particular ethylene oxide, propylene oxide, butylene oxide or preferably epichlorohydrin, the processes for manufacturing a derivative of an epoxide, in particular epoxy resins, the processes for manufacturing chlorinated organic products, in particular 1,2-dichloroethane or 1,2-dichloroethylene, the processes for manufacturing monoisocyanates and polyisocyanates, in particular 4,4′-methylenediphenyl diisocyanate (MDI), toluene diisocyanate (TDI) or hexamethylene-1,6-diisocyanate (HDI) and the processes for manufacturing polycarbonates, in particular 2,2-bis(4-hydroxyphenyl)propane polycarbonate (bisphenol A polycarbonate). The brine may be a combination of brines originating from at least two of these processes. The derivatives of an epoxide, in particular of epichlorohydrin, and the epoxy resins, may be as described in application WO 2008/152044 in the name of SOLVAY (Société Anonyme), of which the content, and more specifically the passage from page 13, line 22, to page 44, line 8, is incorporated herein by reference.

In the process according to the invention, the brine preferably originates from a process for manufacturing epichlorohydrin, from a process for manufacturing epoxy resins, from a process for manufacturing 1,2-dichloroethane or 1,2-dichloroethylene, from a process for manufacturing bisphenol A polycarbonate or from a combination of at least two of these processes, and more preferably from a process for manufacturing epichlorohydrin, from a process for manufacturing epoxy resins, from a process for manufacturing 1,2-dichloroethane or 1,2-dichloroethylene, or from a combination of at least two of these processes.

In the process according to the invention, the brine yet more preferably originates from a process for manufacturing epichlorohydrin, more preferably still from a process for manufacturing epichlorohydrin by dehydrochlorination of dichloropropanol, and very particularly preferably from a process for manufacturing epichlorohydrin by dehydrochlorination of dichloropropanol in which at least one portion of the dichloropropanol was obtained from glycerol and of which at least one fraction of said glycerol is natural glycerol, i.e. glycerol which has been obtained from renewable raw materials. The natural glycerol is as described in application WO 2006/100312 in the name of SOLVAY (Société Anonyme), of which the content, and more specifically the passage from page 4, line 22, to page 5, line 24, is incorporated herein by reference.

The processes for preparing epoxy resins, dichloropropanol and epichlorohydrin can be such as disclosed in International applications WO2005/054167, WO2006/100311, WO2006/100312, WO2006/100313, WO2006/100314, WO2006/100315, WO2006/100316, WO2006/100317, WO2006/106153, WO2007/054505, WO 2006/100318, WO2006/100319, WO2006/100320, WO 2006/106154, WO2006/106155, WO 2007/144335, WO 2008/107468, WO 2008/101866, WO 2008/145729, WO 2008/110588, WO 2008/152045, WO 2008/152043, WO 2009/000773, WO 2009/043796, WO 2009/121853, WO 2008/152044, WO 2009/077528, WO 2010/066660, WO 2010/029039, WO 2010/029153, WO 2011/054769 and WO 2011/054770, filed in the name of SOLVAY, the contents of which are incorporated herein by reference.

In the process according to the invention, at least one part of fourth aqueous composition (D) can be submitted to a venting treatment at a fourth pH value lower than the third pH value in order to obtain a fifth aqueous composition (E). The fourth pH value is generally higher than or equal to 0, preferably higher than or equal to 1, more preferably higher than or equal to 2 and most preferably higher than or equal to 2.5. That fourth pH value is usually lower than or equal to 5 preferably lower than or equal to 4.5, more preferably lower than or equal to 4, and most preferably lower than or equal to 3.5.

In the process according to the invention, the fourth pH value is lower than the third pH value, the difference between the third and the fourth pH value being usually higher than or equal to 0.1 pH unit, preferably higher than or equal to 0.5 pH unit, more preferably higher than or equal to 1 pH unit, still more preferably higher than or equal to 1.5 pH unit, and most preferably higher than or equal to 2 pH unit,. That difference is usually lower than or equal to 4 pH unit, preferably lower than or equal to 3.5 pH unit, and most preferably lower than or equal to 3 pH unit.

The venting treatment of composition (D) is preferably a flashing treatment.

Such a treatment usually allows to remove from composition (D) a second stripped fraction comprising, usually as molecular chlorine, most of the active chlorine remaining in (D) after the treatment at the third pH value. The second stripped fraction can advantageously be recycled to the treatment at the first pH value of the process according to the invention.

In the process according to the invention, at least one part of fifth aqueous composition (E) can be treated with a reducing agent in order to obtain a sixth aqueous solution (F). The reducing agent is preferably selected from the group consisting of a peroxide, a metal sulfite, a metal bisulfite, a metal thiosulfate, and any mixture thereof. The metal is preferably sodium. The peroxide is preferably hydrogen peroxide. The reducing agent is more preferably hydrogen peroxide.

In the process according to the invention, the treatment with the peroxide is usually carried out at a fifth pH value is generally higher than or equal to 6, preferably higher than 8 and more preferably higher than or equal to 9. That sixth pH value is usually lower than or equal to 14, preferably lower than or equal to 13, more preferably lower than or equal to 12, and most preferably lower than or equal to 11.

The process according to the invention may be carried out according to any mode, discontinuous or continuous. The continuous mode is preferred.

In a second embodiment, the invention also relates to a process for manufacturing chlorine comprising feeding the anodic compartment of an electrolysis cell with at least one part of aqueous composition obtained by treating a brine composition by the process of the first embodiment of the invention, preferably one part of aqueous composition (F). The electrolysis cell is preferably a membrane chlor-alkali electrolysis cell. TOC requirements for anolyte of such electrolysis cells are usually very severe. The process according to the invention is particularly well suited for providing aqueous compositions with TOC required for use as anolyte in said electrolysis cells.

In a third embodiment, the present invention also relates to a process for reducing the total content of organic compounds of a first aqueous composition (A) comprising submitting (A) to a treatment with active chlorine at a first pH value in order to obtain a second aqueous composition (B), submitting at least one part of (B) to a venting treatment at a second pH value lower than the first pH value in order to obtain a third aqueous composition (C) and submitting at least one part of (C) to a treatment with active chlorine at a third pH value lower than the second pH value in order to obtain a fourth aqueous composition (D) with a total content of organic compounds lower than the total content of organic compounds of (A).

In that third embodiment, the organic compounds are preferably selected from the group consisting of glycerol, monochloropropanediols, dichloropropanols, acetic acid, propionic acid, butyric acid, capric acid, caproic acid, caprylic acid, and any mixture thereof.

The features disclosed for the first embodiment hereabove are applicable to the second embodiment.

In the process according to the invention, each of the treatments can be carried out in one or more vessels. Those vessels can be combined according to any arrangement, in series, in parallel, and any combination thereof. The treatment of composition (A) at the first pH value is usually carried out in more than one vessel, frequently two and often three. Those vessels are preferably arranged in series.

The equipment in which the process is carried out is generally made of or covered with a material that withstands the process conditions. This material may be chosen from the group consisting of carbon steels, stainless steels, enamelled steels, compressed steels, titanium, titanium alloys and nickel alloys, polymers, coatings using resins such as epoxy resins and phenolic resins, and combinations of at least two thereof. Polymers can be for instance, polyolefins, such as polypropylene and polyethylene, chlorinated polymers, such as polyvinyl chloride and chlorinated polyvinyl chloride, fluorinated polymers, such as perfluorinated polymers, like for example polytetrafluoroethylene, copolymers of tetrafluorethylene and hexafluoropropylene, and poly(perfluoropropyl vinyl ether), such as partially fluorinated polymers, like for example polyvinylidene fluoride and copolymers of ethylene and chlorotrifluoroethylene, sulphur-containing polymers, such as polysulphones and polysulphides, in particular that are aromatic. The polymers may be used in bulk or shrunk-fit form or as a coating. The material is preferably chosen from the group consisting of titanium and titanium alloys and more preferably from the group consisting of titanium alloys. The titanium alloys are preferably chosen from the alloys comprising titanium and palladium, titanium and ruthenium, or titanium, nickel and molybdenum. Alloys comprising titanium and palladium or titanium and ruthenium are more particularly preferred and those comprising titanium and palladium are very particularly preferred.

The process according to the invention can be combined with any of the processes disclosed in applications WO 2008/152043, WO 2009/095429, WO 2012/016872, WO 2012/025468 and PCT/EP2012/068016, the content of which are incorporated herein by reference.

The examples below are intended to illustrate the invention without, however, limiting it.

### Example 1 (According to the Invention)

A first reactor is continuously fed with an aqueous composition (A) with a TOC of 1.483 g of C/l at a flow rate of 453 g/h/l of reactor, a hypochlorite aqueous solution (13% wt of NaOCl) at a flow rate of 78.7 g/h/l of the first reactor liquid volume and an aqueous solution of caustic soda (32% wt of NaOH) at a flow rate of 8.7 g/h/l of first reactor. The first reactor is operated at 120° C., at 2.5 bar absolute, at a pH of 8.5 and at a residence time of 2 h.

A flash vessel is continuously fed with the stream exiting from the first reactor at a flow rate of 31629 g/h/l of flash liquid volume and with an aqueous solution (20% wt) of hydrogen chloride at a flow rate of 682.6 g/h/l. The flash vessel is operated at 120° C., at 2.5 bar abs, at a pH of 6.0 and at a liquid residence time of 2 min.

A second reactor is continuously fed with the stream exiting from the flash vessel at a flow rate of 6438 g/h/l of the second reactor liquid volume and with a hydrogen chloride solution (20% wt of HC1) at flow a rate of 31.9 g/h/l of reactor. The second reactor is operated at 120° C., at 4.5 bar absolute, at a pH of 4.5 and at a residence time of 10 min.

At the exit of the second reactor the TOC reduction calculated from the flow rate of the TOC of the stream exiting the second reactor and from the flow rate of the TOC of the stream of aqueous composition (A) is of 99.29% (which corresponds to a TOC of 8.5 mg of C/l at outlet of second reactor).

### Example 2 (Not According to the Invention)

The procedure of example 1 is followed except that the flash vessel is absent.

At the exit of the second reactor the TOC reduction is of 98.84% (which corresponds to a TOC of 14 mg of C/L at outlet of second reactor)

1. A process for reducing the Total Organic Carbon of a first aqueous composition (A) comprising submitting (A) to a treatment with active chlorine at a first pH value in order to obtain a second aqueous composition (B), submitting at least one part of (B) to a venting treatment at a second pH value lower than the first pH value in order to obtain a third aqueous composition (C) and submitting at least one part of (C) to a treatment with active chlorine at a third pH value lower than the second pH value in order to obtain a fourth aqueous composition (D) with a Total Organic Carbon lower than the Total Organic Carbon of (A).

2. The process according to claim 1 wherein the first pH value is higher than or equal to 7.

3-5. (canceled)

6. The process according to claim 1 wherein the first pH value is lower than or equal to 13.

7-11. (canceled)

12. The process according to claim 1 wherein the second pH value is higher than or equal to 5.

13-14. (canceled)

15. The process according to claim 1 wherein the second pH value is lower than or equal to 8.

16-19. (canceled)

20. The process according to claim 1 wherein the third pH value is higher than or equal to 3.5.

21. (canceled)

22. The process according to claim 1 wherein the third pH value is lower than or equal to 6.

23-25. (canceled)

26. The process according to claim 1, wherein the difference between the first and the second pH value is higher than or equal to 0.1 pH unit.

27-30. (canceled)

31. The process according to claim 1, wherein the difference between the first and the second pH value is lower than or equal to 4 pH unit.

32-33. (canceled)

34. The process according to claim 1, wherein the difference between the second and the third pH value is higher than or equal to 0.1 pH unit.

35-38. (canceled)

39. The process according to claim 1, wherein the difference between the second and the third pH value is lower than or equal to 4 pH unit.

40-41. (canceled)

42. The process according to claim 1 wherein said first aqueous composition (A) comprises sodium chloride in a content which is higher than or equal to 5 g/kg of said first aqueous composition and lower than or equal to 270 g/kg of said first aqueous composition.

43. The process according to claim 1 wherein said first aqueous composition (A) contains an organic compound selected from the group consisting of glycerol, monochloropropanediol, dichloropropanol, acetic acid propionic acid, butyric acid, capric acid, caproic acid, caprylic acid, and any mixture thereof

44. The process according to claim 1 wherein the venting treatment is a flashing treatment, a stripping treatment or a combination thereof

45. The process according to claim 44 wherein the venting treatment is a flashing treatment.

46. The process according to claim 45 wherein the flashing treatment is carried out at a pressure higher than or equal to 0.5 bar and lower than or equal to 10 bar, and at a temperature higher than or equal to 80° C. and lower than or equal to 180° C.

47. The process according to claim 44 wherein the venting treatment is a stripping treatment carried out in the presence of a stripping agent selected from the group consisting of air, oxygen-depleted air, nitrogen, oxygen, steam, and mixtures of at least two thereof

48. The process according to claim 1 wherein the active chlorine is provided as sodium hypochlorite.

49. The process according to claim 1 wherein, at least one part of said fourth aqueous composition (D) is submitted to the venting treatment at a fourth pH value lower than the third pH value in order to obtain a fifth aqueous composition (E).

50. The process according to claim 49 wherein, at least one part of said fifth aqueous composition (E) is treated with a reducing agent selected from the group consisting of a peroxide, a metal sulfite, a metal bisulfate, a metal thiosulfate, and any mixture thereof, in order to obtain a sixth aqueous solution (F).

51. The process according to claim 1, wherein the first aqueous composition (A) is a brine and has been generated in a process selected from the group consisting of processes for manufacturing epoxides, processes for manufacturing a derivative of an epoxide, processes for manufacturing chlorinated organic products, processes for manufacturing monoisocyanates or polyisocyanates, processes for manufacturing polycarbonates, and any combination of at least two of them.

52. The process according to claim 51, wherein the epoxide is epichlorohydrin.

53. The process according to claim 52 wherein the epichlorohydrin has been obtained by dehydrochlorination of dichloropropanol, at least portion of the dichloropropanol having been obtained from glycerol, at least one fraction of which is natural glycerol.

54. The process according to claim 51, wherein the derivative of an epoxide is an epoxy resin.

55. The process according to claim 51, wherein the chlorinated organic product is 1,2-dichloroethane or 1,2-dichloroethylene.

56. The process according to claim 51, wherein the polyisocyanate is selected from the group consisting of 4,4′-methylenediphenyl diisocyanate, toluene diisocyanate, hexamethylene-1,6-diisocyanate and any mixture thereof

57. The process according to claim 51, wherein the polycarbonate is 2,2-bis(4-hydroxyphenyl)propane polycarbonate.

58. The process for manufacturing chlorine comprising feeding the anodic compartment of a membrane chlor-alkali electrolysis cell with at least one part of the aqueous composition obtained according to the process of claim 1.
